(19) United States
(12) Patent Application Publication
(10) Pub. No.: US 2009/0058071 A1
(43) Pub. Date: Mar. 5, 2009

(54) TRAVEL GUIDE BOOKLET WITH REMOVABLE CARDS

(76) Inventors: Hui Ting Cheng, Shanghai (CN); Marusia Musacchio, Shanghai (CN)

Correspondence Address: FLIESLER MEYER LLP, 650 CALIFORNIA STREET, 14TH FLOOR, SAN FRANCISCO, CA, 94108, US

(21) Appl. No.: 12/199,673

(22) Filed: Aug. 27, 2008

Related U.S. Application Data
(60) Provisional application No. 60/969,089, filed on Aug. 30, 2007.

(51) Int. Cl. G09B 29/00; B42D 15/00

(52) U.S. Cl. 283/34; 283/56

(57) ABSTRACT

A booklet with removable cards, together with a variety of systems, methods, and applications associated therewith. Embodiments can be incorporated into books, booklets, maps, catalogs, travel guides, schedules, and other printed information and materials. In one embodiment, the booklet comprises a travel guide having a plurality of information cards as pages. Each information card can provide information about a travel destination, language translation, cultural pointers, or other information. The cards are bound using a first ring fastener that can be opened by the reader so that one or more cards can be removed from the booklet, and carried in a wallet, on a second ring fastener, or as a second booklet, distinct from the main booklet.

### CLAIM OF PRIORITY

This application claims the benefit of priority to U.S. Provisional Patent Application titled “TRAVEL GUIDE BOOKLET WITH REMOVABLE CARDS”; Application No. 60/969,089; filed Aug. 30, 2007, and incorporated herein by reference.

### FIELD OF THE INVENTION

The invention is generally related to books, booklets, maps, catalogs, travel guides, schedules, and other printed information and materials, and particularly to a booklet with removable cards, and to a variety of systems, methods, and applications associated therewith.

### BACKGROUND

Printed guide books and booklets are used for a variety of purposes, including travel guides, dictionaries, collectible guides, and other reference books. The vast majority of guide books are published as bound books, using traditional binding techniques. This is acceptable for most purposes since the intent is to provide the reader with a complete set of information. One of the problems however, is that the reader is typically required to then carry the complete book with them, wherever they feel they may need to refer to that book. The reader may typically also have to search an index or a set of content pages to find the particular portion of the book they are interested in at that moment in time. Some people may choose to bookmark or use tabs to mark pages of particular interest, but even then they will have to search through their tabbed and marked pages, overlooking all of the other pages; and of course the addition of bookmarks and tabs adds to the overall size, weight, and bulk of the book.

The problem of book size is particularly acute with regard to travel guides and similar travel or activity-oriented guide books. Many readers like to plan trips in advance, so favor a larger guide book, with a greater variety of listings, and more detailed information about each listing. However, once having made their travel plans and on the road the reader is typically more interested in having information about their planned itinerary, and is unlikely to need the additional information a large guide book provides. The travel publication industry has responded by publishing both larger and more detailed guidebooks that one might read in their hotel, and pocket-sized books that one might carry. One problem with this approach is that there is rarely any consistent overlap between the listings in each of the variety of books, so that readers often end up taking both books along anyway, which simply exacerbates the problem.

### SUMMARY

Described herein is a booklet with removable cards, together with a variety of systems, methods, and applications associated therewith. Embodiments of the invention can be incorporated into books, booklets, maps, catalogs, travel guides, schedules, and other printed information and materials. In one embodiment, the booklet comprises a travel guide having a plurality of information cards as pages. Each information card can provide information about a travel destination, language translation, cultural pointers, or other information. The plurality of information cards are bound using a first ring fastener that can be opened by the reader so that one or more cards can be removed from the booklet. The booklet further comprises a second ring fastener. Cards that are removed from the booklet can be placed onto the second ring fastener and carried separately as a second booklet, distinct from the main booklet. In this manner the reader can have a complete set of information when they wish to refer to it, but can carry with them an abbreviated set of pages suitable for a day's sightseeing. Additional features of the booklet and of the cards are described herein.

### BRIEF DESCRIPTION OF THE FIGURES

FIG. 1 is an illustration of a booklet (closed) with removable cards in accordance with an embodiment.

FIG. 2 is another illustration of a booklet (closed) with removable cards in accordance with an embodiment, including a primary ring fastener and a secondary ring fastener.

FIG. 3 is another illustration of a booklet (closed) with removable cards in accordance with an embodiment, including a primary ring fastener and a secondary ring fastener.

FIG. 4 is another illustration of a booklet (closed) with removable cards in accordance with an embodiment, including a primary ring fastener and a secondary ring fastener.

FIG. 5 is an illustration of a booklet cover in accordance with an embodiment, showing an example of how each booklet cover can represent the information for a particular city or region.

FIG. 6 is an illustration of the back side of a booklet cover in accordance with an embodiment.

FIG. 7 is another illustration of a booklet in accordance with an embodiment, showing an example of an index page

FIG. 8 is another illustration of a booklet in accordance with an embodiment, showing a page of suggested itinerary information for a travel destination, in this instance Shanghai.

FIG. 9 is another illustration of a booklet in accordance with an embodiment, showing an example of a symbols page.

FIG. 10 is another illustration of a booklet in accordance with an embodiment, showing an example page (front and back) of information for a weekend getaway destination (in this instance in English and Chinese).

FIG. 11 is another illustration of a booklet in accordance with an embodiment, showing an example page (front) of information for a local attraction.

FIG. 12 is another illustration of a booklet in accordance with an embodiment, showing an example page (back) of information for a local attraction.

FIG. 13 is another illustration of a booklet in accordance with an embodiment, showing an example page (front) of information for a restaurant.

FIG. 14 is another illustration of a booklet in accordance with an embodiment, showing an example page (back) of information for a restaurant.

FIG. 15 is another illustration of a booklet in accordance with an embodiment, showing an example page (front) of information for an entertainment venue.

FIG. 16 is another illustration of a booklet in accordance with an embodiment, showing an example page (back) of information for an entertainment venue.

FIG. 17 is another illustration of a booklet in accordance with an embodiment, showing an example page (front and back) of information for a restaurant.

FIG. 18 is an illustration of a booklet in accordance with an embodiment, showing a (front) page of translation information, and also the symbols used for each category.

FIG. 19 is an illustration of a booklet in accordance with an embodiment, showing the reverse page of translation information.

FIG. 20 is an illustration of a booklet in accordance with an embodiment, showing a page of food-ordering information.

FIG. 21 is an illustration of a booklet in accordance with an embodiment, showing a (front) page of railway information.

FIG. 22 is an illustration of a booklet in accordance with an embodiment, showing the reverse page of railway information, including destinations (in this instance in English and Chinese).

FIG. 23 is an illustration of booklet cards or pages in accordance with an embodiment, showing a variety of page features, including the card/page number, and index pointers to related cards or pages.

FIG. 24 is an illustration of booklet cards or pages in accordance with an embodiment, showing a variety of page features, including the card/page number, and index pointers to related cards or pages.

FIG. 25 is an illustration of a booklet in accordance with an embodiment, showing a folded map page.

FIG. 26 is an illustration of a booklet in accordance with an embodiment, showing a map page that can be opened.

FIG. 27 is an illustration of a booklet in accordance with an embodiment, showing an opened map page.

FIG. 28 is an illustration of a booklet with removable cards in accordance with an embodiment, showing how individual cards can be removed from the primary ring fastener.

FIG. 29 is an illustration of a booklet with removable cards in accordance with an embodiment, showing how individual cards can be used to create a set of cards for a day trip, or an extended trip.

FIG. 30 is an illustration of a booklet with removable cards in accordance with an embodiment, showing how one or more cards that are removed from the primary ring fastener can be added to the secondary ring fastener.

FIG. 31 is an illustration of a booklet in accordance with an embodiment, showing how the ring fasteners can be separated to create two booklets.

FIG. 32 is an illustration of how individual cards can be used to create a set of cards for a day trip, or an extended trip, wherein the cards can be linked through common symbols and numeric identifiers.

FIG. 33 is an illustration of how the cards can be linked through common symbols and numeric identifiers, including using the identifier numbers on a card to find which cards may be of interest to the reader.

FIG. 34 is an illustration of a booklet in accordance with an embodiment, showing how the ring fasteners can be separated to create two booklets (shown here side-by-side), including a primary booklet and a secondary booklet.

FIG. 35 is an illustration of a booklet with removable cards in accordance with an embodiment, showing how the rings or fasteners can be connected to crate two sets of cards (a complete set, minus the day set) for easy reference to the day set during the day.

FIG. 36 is an illustration of a booklet with removable cards in accordance with an embodiment, showing how cards that were removed from the primary ring fastener and added to the secondary ring fastener can be carried separately.

FIG. 37 is an illustration of a booklet in accordance with an embodiment, showing how the secondary booklet can include a fold-out map.

FIG. 38 is an illustration of a booklet with removable cards in accordance with an embodiment, showing how cards can be packaged and/or carried in a pouch, holder, or wallet, instead of a secondary ring or fastener.

FIG. 39 is another illustration of a booklet with removable cards in accordance with an embodiment, showing how cards can be packaged and/or carried in a pouch, holder, or wallet, instead of a secondary ring or fastener.

FIG. 40 is another illustration of a booklet with removable cards in accordance with an embodiment, showing how cards can be packaged and/or carried in a pouch, holder, or wallet, instead of a secondary ring or fastener.

FIG. 41 is another illustration of a booklet with removable cards in accordance with an embodiment, showing how cards can be packaged and/or carried in a pouch, holder, or wallet, instead of a secondary ring or fastener.

FIG. 42 is another illustration of a booklet with removable cards in accordance with an embodiment, showing how cards can be packaged and/or carried in a pouch, holder, or wallet, instead of a secondary ring or fastener.

FIG. 43 is an illustration of a booklet with removable cards in accordance with an embodiment, showing how the entire booklet (or several booklets) can be packaged and/or carried in a pouch, holder, or wallet.

### DETAILED DESCRIPTION

Described herein is a booklet with removable cards, together with a variety of systems, methods, and applications associated therewith. Embodiments of the invention can be incorporated into books, booklets, maps, catalogs, travel guides, schedules, and other printed information and materials.

In accordance with an embodiment referred to herein as “Zhao Cards”, the booklet provides a way for the reader to focus on travel destinations and deal with other travel-related and everyday tasks, that would be otherwise difficult to get around, or to handle, due to language and cultural barriers. One of the objectives is to provide a solution to travelers or tourists who prefer not to carry a bulky guidebook while traveling. Not only is it light and compact, the booklet provided by “Zhao Cards” is designed to especially address common language barriers that are typical of tourists visiting destinations where the different language is itself a barrier. In many instances the booklet or guide allows the traveler or tourist to get around town, without worrying about not being able to speak the language. It is particularly useful for visitors to a city or region, who want to experience that city or regions just as the locals do.

In accordance with an embodiment, the booklet comprises a travel guide having a plurality of information cards as pages. Each information card can provide information about a travel destination, language translation, cultural pointers, or other information. The plurality of information cards are bound using a first ring fastener that can be opened by the reader so that one or more cards can be removed from the booklet. The booklet further comprises a second ring fastener. Cards that are removed from the booklet can be placed onto the second ring fastener and carried separately as a second booklet, distinct from the main booklet. In this manner the reader can have a complete set of information when they wish to refer to it, but can carry with them an abbreviated set of pages suitable for a day's sightseeing.

Some of the features and advantages of various embodiments can include:

The information on each card can be written by people who live in the city they are writing about, so that each venue can be carefully handpicked and personally visited, for a better local feel and quality of information.

Each group of cards can use a distinct color for each city or region, and can then organize each category within that city or region by gradually changing the color of the card or a symbol, border, or shading of the card.

Removable cards or pages can allow the reader to take only those cards which they need for a daytrip, or for an extended trip.

The second ring fastener can be used as a “day ring” which allows the day traveler to keep selected cards (and optionally a map) in a particular order, for better planning and ordering of the day's activities.

The booklet can be designed to fit in a wallet or purse, and the removable cards can be made to a standard credit card size to fit in a standard wallet. Different kinds of accessories such as matching color pouches, holders, and wallets can be provided for carrying the cards.

The booklet can serve as a language tool, in that both a reader's own language (i.e. the reader's language of choice, for example, English) and the language of the destination city (for example, Chinese, Spanish, Japanese, or another destination language) is written on the cards.

The booklet or guide can be easily and frequently updated, including updating one or several cards as required, so that it is always up-to-date.

Within the booklet, each category can be illustrated by a specific color and indicated by an icon on the back of the card.

All of the cards can be numbered and divided into several categories, such as: Sightseeing, Food, Entertainment & Activities, Shopping, and Other

In accordance with an embodiment, the Food section provides several options for ordering, both written in English (or the reader's language of choice) and the language of the city the reader is traveling in. This is especially useful for venues that do not have the menu options provided in English (or in the reader's language of choice).

In accordance with an embodiment, the Shopping section provides an estimate price of how much the reader should pay per item, and provides the reader with suggestions on what unique items to purchase in a particular store.

In accordance with an embodiment, the Other section provides information and words for ordering drinks, common dishes, emergency numbers, and websites for cultural activities and events.

On the back of each card, there are two numbers which represent two recommended venues that are near the area you are in. In general, they are within walking distance, but in some cases, they are just a short-cab ride away

A martini glass symbol on some cards of the food section indicates that the venue has a bar.

A bowl of noodles on some cards of the food section indicates that food is served in an entertainment venue.

A map can be included (in a card or fold-out format) that includes all the venues, indicated by the card number.

An online or mobile system can be provided, so that the booklet or individual card information can also be provided online, or using a mobile device, PDA, or cell phone.

Additional features of the booklet and of the cards are described herein.

FIG. 1 is an illustration of a booklet 100 (closed) with removable cards in accordance with an embodiment. As shown in FIG. 1, each booklet can describe a particular city or region, such as in this example the city of Shanghai. Similarly, in accordance with other embodiments each booklet could be used as a guide to describe information related to a particular hobby, or an activity.

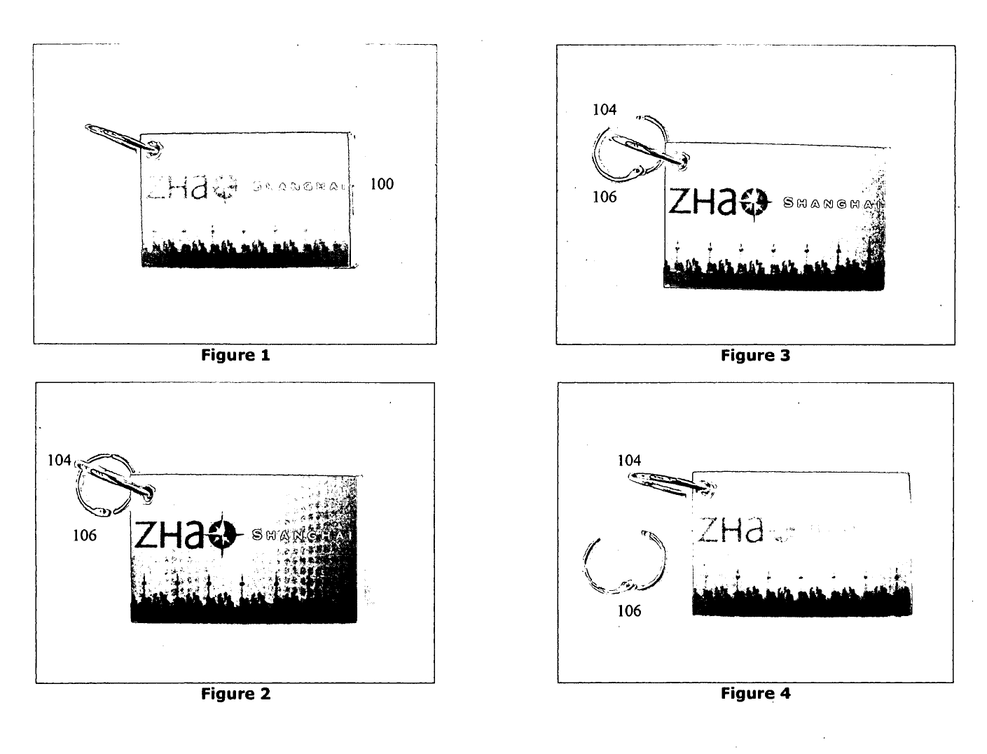

FIG. 2 is another illustration of a booklet (closed) with removable cards in accordance with an embodiment, including a primary ring fastener 104 and a secondary ring fastener 106. As shown in FIG. 2, in accordance with an embodiment, the primary and secondary ring fasteners are made of a metallic or a steel-like material, and open to allow the rings to be separated. In accordance with other embodiments the fasteners can be made of a different material, such as plastic, and can be formed in a different shape. In accordance with other embodiments, many ring fasteners (i.e. a plurality of the secondary ring fasteners) can be provided, allowing for the creation of multiple booklets. In accordance with other embodiments that do not include a secondary ring fastener, pages can still be removed and kept or carried in the various wallet formats, as described in further detail below

FIG. 3 is another illustration of a booklet (closed) with removable cards in accordance with an embodiment, including a primary ring fastener and a secondary ring fastener. As shown in FIG. 3, in accordance with an embodiment, either one or both of the primary and secondary ring fasteners can be opened to allow the rings or fasteners to be separated.

FIG. 4 is another illustration of a booklet (closed) with removable cards in accordance with an embodiment, including a primary ring fastener and a secondary ring fastener. As shown in FIG. 4, the fasteners can be completely separated and used to create two booklets (or in the case of a plurality of ring fasteners then a plurality of booklets).

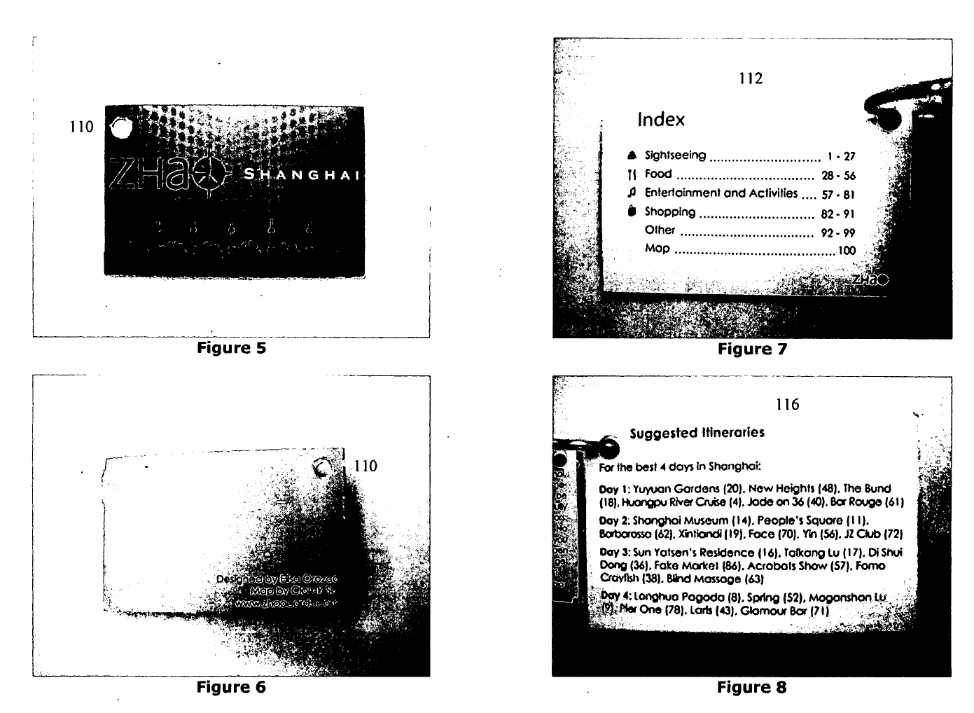

FIG. 5 is an illustration of a booklet cover in accordance with an embodiment, showing an example of how each booklet cover can represent the information for a particular city or region. In particular, each city or region can have a particular color scheme associated therewith, or city-specific graphical designs.

FIG. 6 is an illustration of the back side of a booklet cover in accordance with an embodiment. FIGS. 5 and 6 also illustrate that in accordance with an embodiment each of the cards is punched in a corner to provide a hole 110 to insert the ring or fastener through.

FIG. 7 is another illustration of a booklet in accordance with an embodiment, showing an example of an index page 112. Each of the various activities for a region, such as sightseeing, food, entertainment and shopping, can be represented by a symbol. Each of the cards that describe the activities can then be marked with an appropriate card number that is unique to that card, together with an appropriate symbol for ease of use in locating and sorting.

FIG. 8 is another illustration of a booklet in accordance with an embodiment, showing a page of suggested itinerary information 116 for a travel destination, in this instance Shanghai. As shown in this example, the card includes a suggested itinerary spanning 4 days, and including several attractions on each day. Each of the named attractions includes a number in parentheses. The number corresponds to the card number for the card that describes that attraction in further detail.

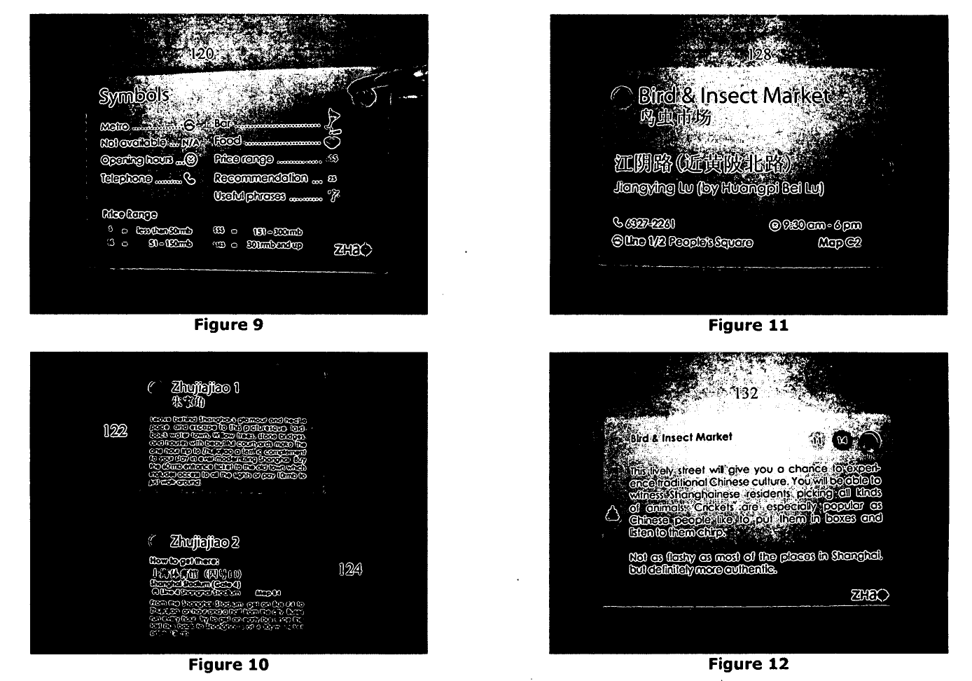

FIG. 9 is another illustration of a booklet in accordance with an embodiment, showing an example of an symbols page 120. Each card can also include activity symbols, such as nearest metro station, opening hours, drink and food options, price range, and recommendation value. This allows the cards to be marked with the appropriate symbol for ease of use in picking preferred cards for a day's activities.

FIG. 10 is another illustration of a booklet in accordance with an embodiment, showing an example page (front 122 and back 124) of information for a weekend getaway destination (in this instance in English and Chinese). The card includes information about how to get there, and other useful information, printed, for example, both in English and in Chinese. This allows the card to be, for example, handed to a taxicab driver or a local person, if the reader needs assistance. The reader does not need to know the local language, since they can read the card in, say, their own English language, and then hand the card to the local-speaking recipient so that the local-speaking recipient can read the card in their own, local language.

FIG. 11 is another illustration of a booklet in accordance with an embodiment, showing an example page (front) of information for a local attraction 128.

FIG. 12 is another illustration of a booklet in accordance with an embodiment, showing an example page (back) of information for a local attraction 132. Since the information is provided by locals, and is easily updated from one version of the booklet to another, it more readily captures the local's perspective on that attraction, which is a common failing in traditional guide books.

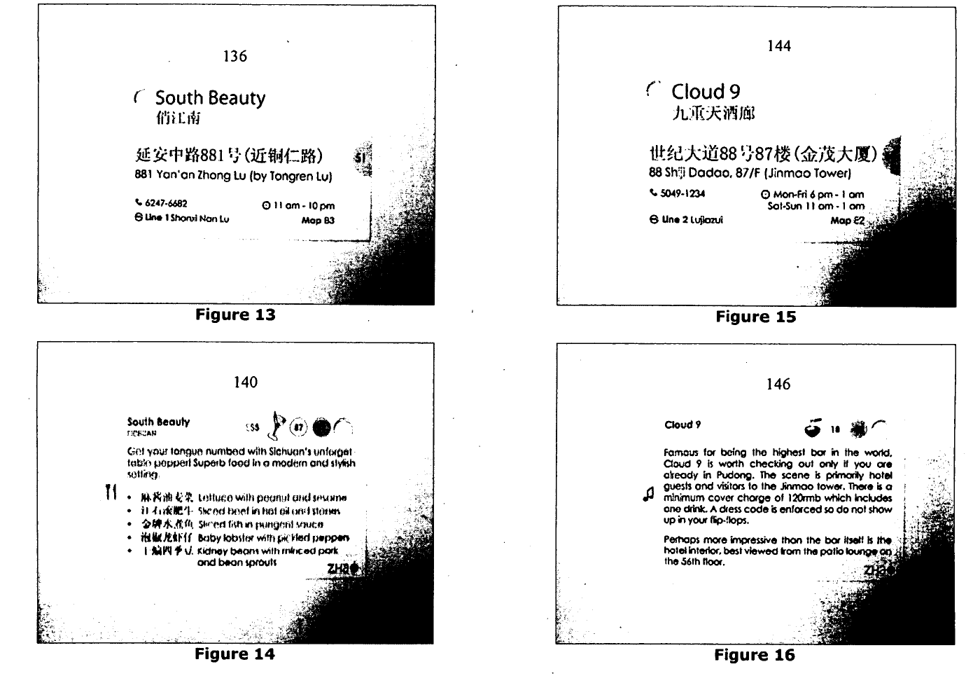

FIG. 13 is another illustration of a booklet in accordance with an embodiment, showing an example page (front) of information for a restaurant 136.

FIG. 14 is another illustration of a booklet in accordance with an embodiment, showing an example page (back) of information for a restaurant 140. As with the attraction destinations, a reader can order items from a menu by reading, in this instance the English version of the food item, and then handing the card to a local-speaking recipient (in this instance Chinese) and pointing to the appropriate entry. This eliminates the need to know the local language for the food item, and also eliminates the need for the reader to try and pronounce a phonetic version of the local word. They can communicate instead by showing or handing out the card and pointing to the appropriate entry.

FIG. 15 is another illustration of a booklet in accordance with an embodiment, showing an example page (front) of information for an entertainment venue 144.

FIG. 16 is another illustration of a booklet in accordance with an embodiment, showing an example page (back) of information for an entertainment venue 146.

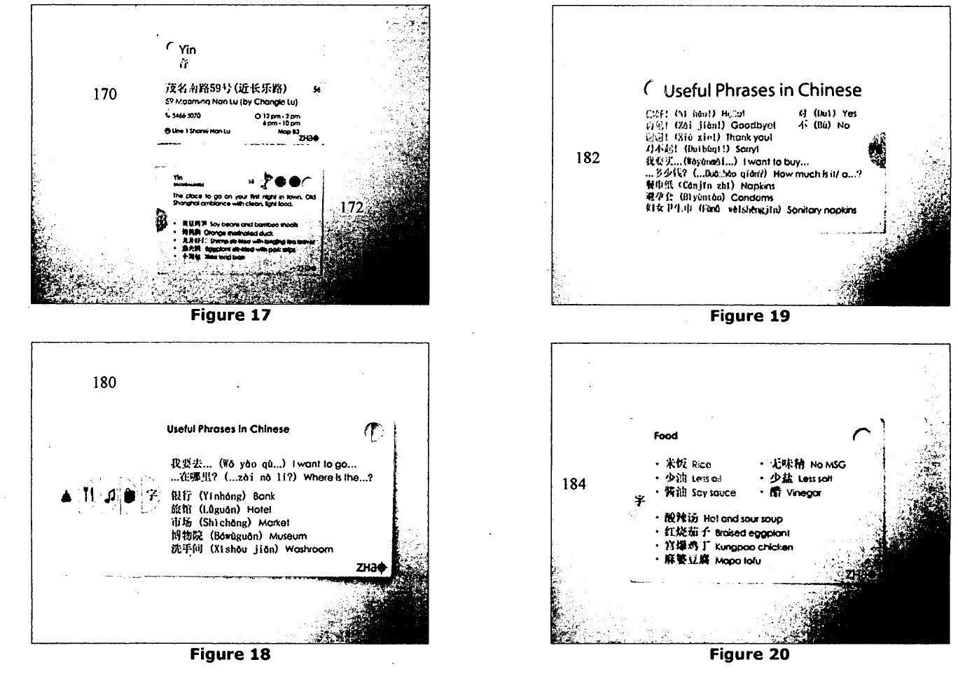

FIG. 17 is another illustration of a booklet in accordance with an embodiment, showing an example page (front 170 and back 172) of information for a restaurant.

FIG. 18 is an illustration of a booklet in accordance with an embodiment, showing a (front) page of translation information 180, and also the symbols used for each category.

FIG. 19 is an illustration of a booklet in accordance with an embodiment, showing the reverse page of translation information 182.

FIG. 20 is an illustration of a booklet in accordance with an embodiment, showing a page of food-ordering information 184.

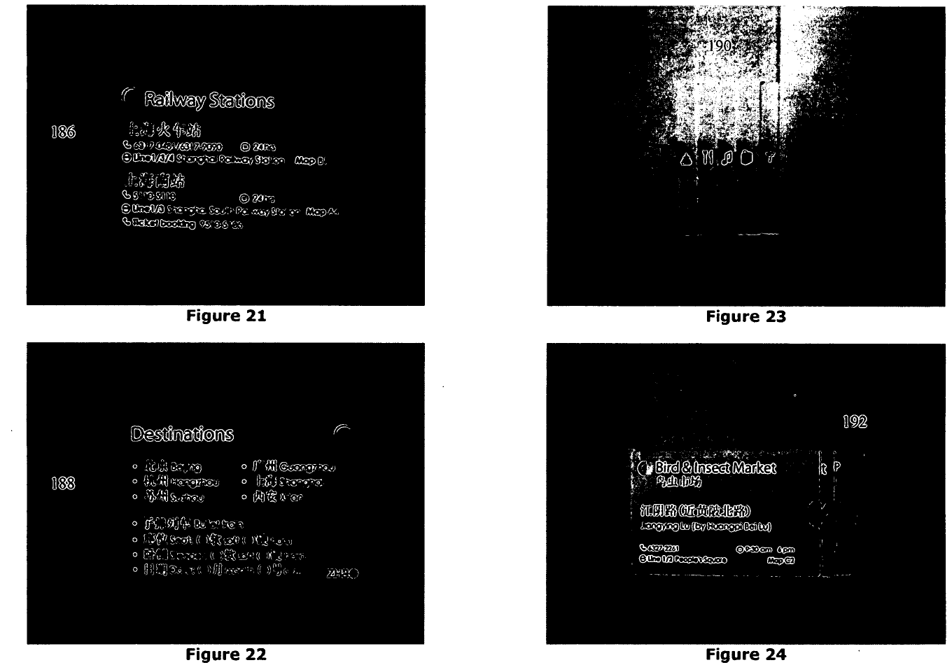

FIG. 21 is an illustration of a booklet in accordance with an embodiment, showing a (front) page of railway information 186. As with the attraction destinations, a reader can locate train stations by handing the card to a taxicab driver, train station operator, or local-speaking recipient and pointing to the appropriate entry.

FIG. 22 is an illustration of a booklet in accordance with an embodiment, showing the reverse page of railway information 188, including destinations (in this instance in English and Chinese). Having located the train station using FIG. 21 above, the reader can then point to appropriate entries on the card to purchase their desired tickets.

FIG. 23 is an illustration of booklet cards or pages in accordance with an embodiment, showing a variety of page features, including the card/page number, and index pointers to related cards or pages. When carried or placed in a wallet, the cards can be fanned out 190 so that the margin symbols are displayed, allowing the reader to quickly locate the cards they need at that particular point in time.

FIG. 24 is an illustration of booklet cards or pages in accordance with an embodiment, showing a variety of page features, including the card/page number, and index pointers to related cards or pages.

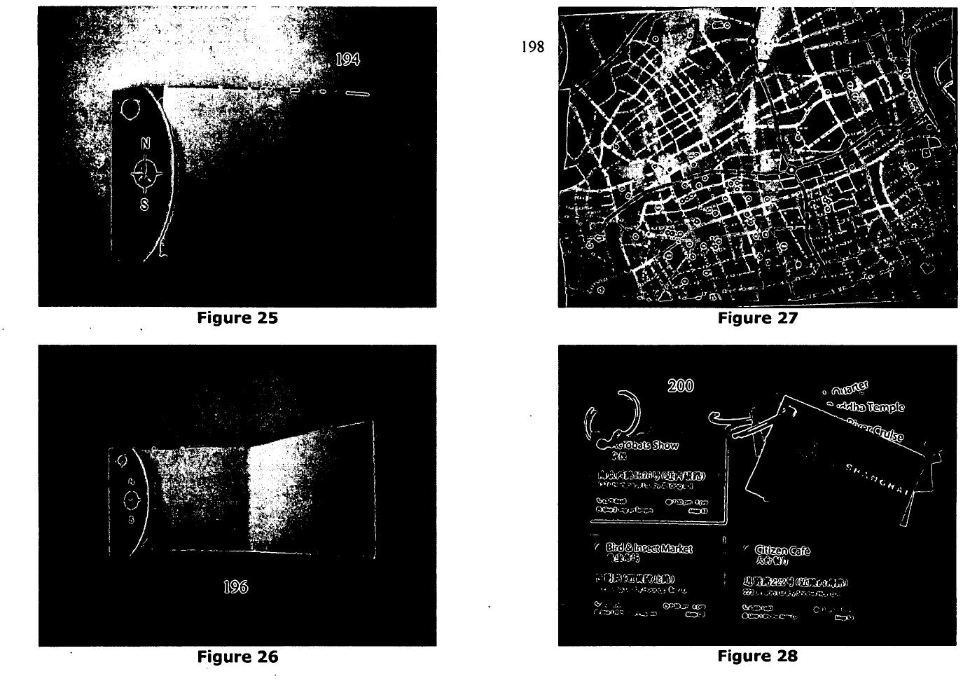

FIG. 25 is an illustration of a booklet in accordance with an embodiment, showing a folded map page 194. A North-South indicator indicates the orientation of the map.

FIG. 26 is an illustration of a booklet in accordance with an embodiment, showing a map page that can be opened 196.

FIG. 27 is an illustration of a booklet in accordance with an embodiment, showing an opened map page. Each of the cards can be represented on the map using the card number that is unique to each card 198.

FIG. 28 is an illustration of a booklet with removable cards in accordance with an embodiment, showing how individual cards can be removed 200 from the primary ring fastener.

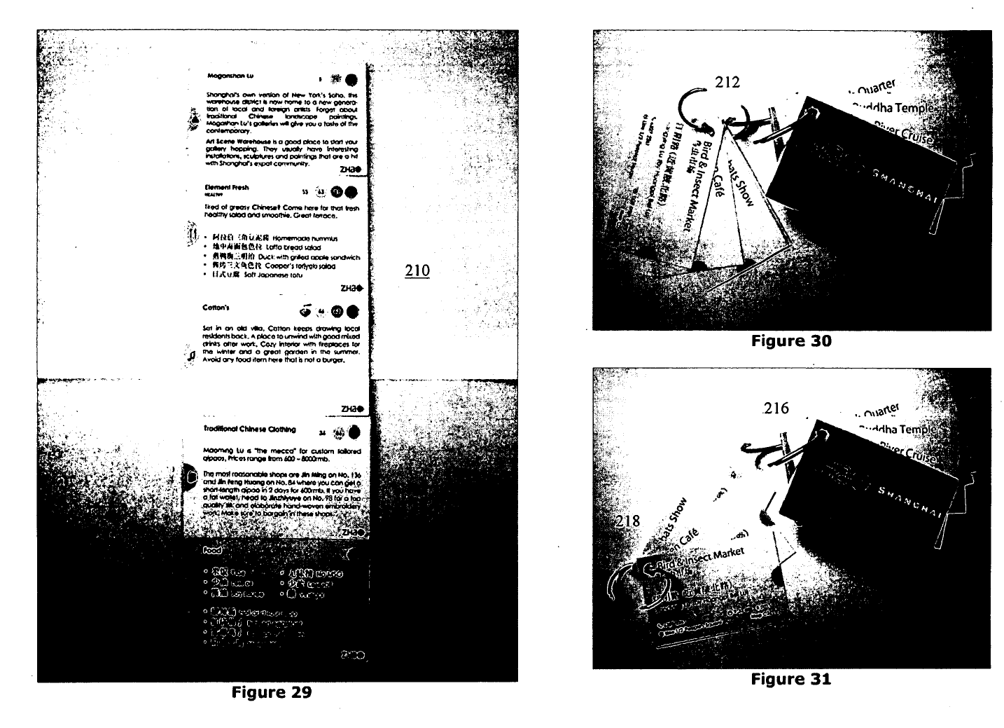

FIG. 29 is an illustration of a booklet with removable cards in accordance with an embodiment, showing how individual cards can be used to create a set of cards for a day trip, or an extended trip 210.

FIG. 30 is an illustration of a booklet with removable cards in accordance with an embodiment, showing how one or more cards that are removed from the primary ring fastener can be added to the secondary ring fastener 212.

FIG. 31 is an illustration of a booklet in accordance with an embodiment, showing how the ring fasteners can be separated to create two booklets 216, 218.

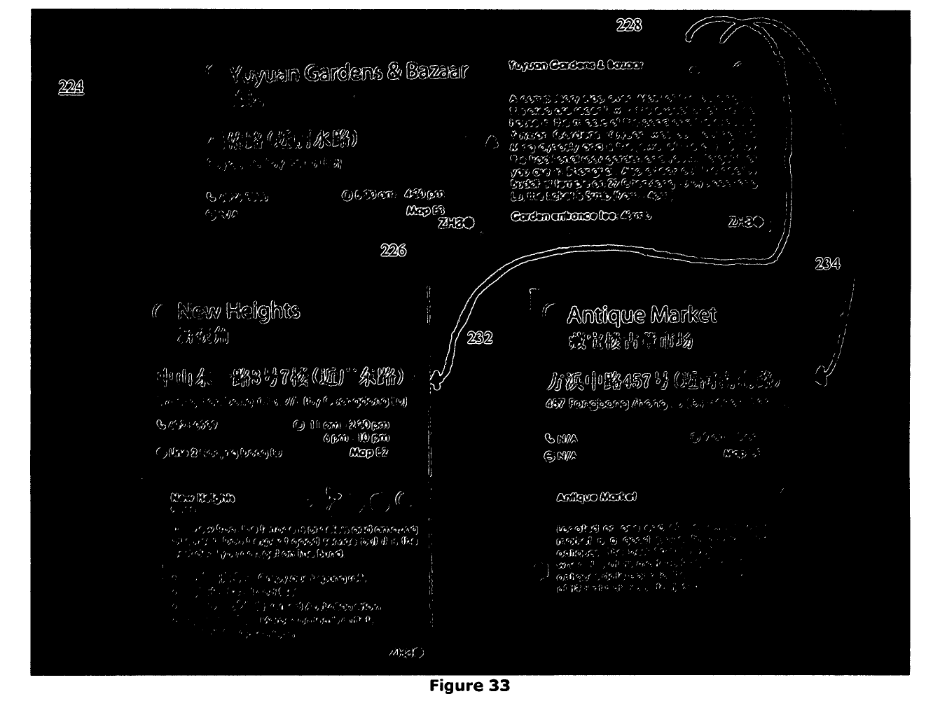

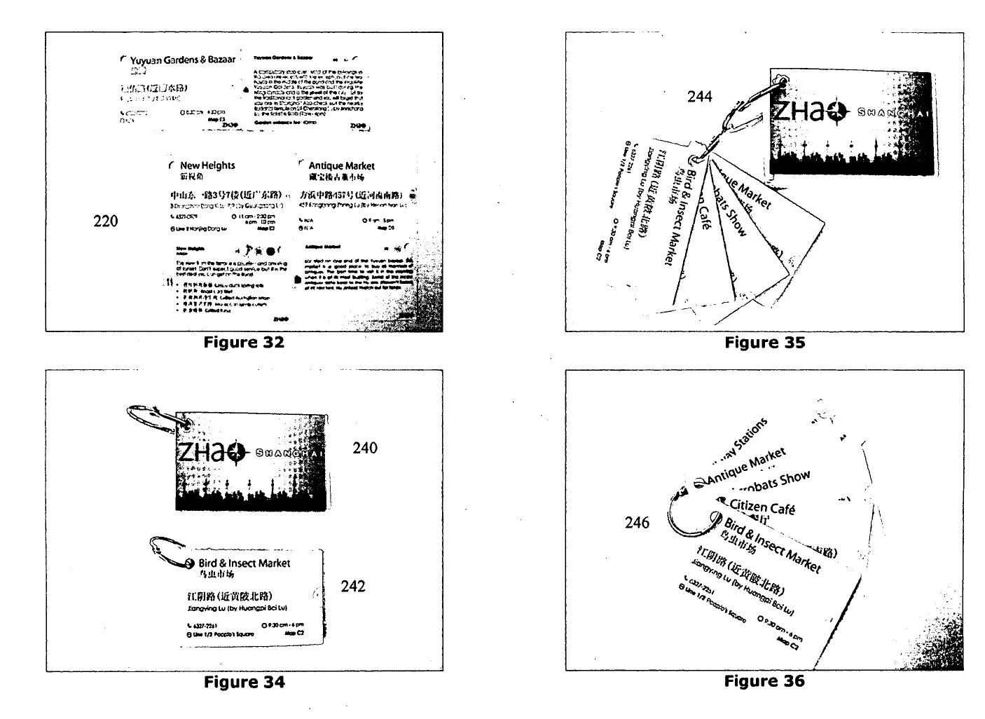

FIG. 32 is an illustration of how individual cards can be used to create a set of cards for a day trip, or an extended trip, wherein the cards can be linked through common symbols and numeric identifiers 220.

FIG. 33 is an illustration 224 of how the cards can be linked through common symbols and numeric identifiers, including using the identifier numbers on a card to find which cards may be of interest to the reader. That card can then be added to the set of cards if the reader so desires. In this example, the reader has selected card 20 for Yuayuan Gardens & Bazaar (236). The card includes suggestions 238 for nearby attractions including the numbers 48 and 82. If the reader selects cards 48 and 82 (232, 234) they will find them to be New Heights and Antique Market respectively. If the reader desires, then these cards can then be added into their set to create an itinerary for the day. This feature allows the reader to browse through the set of cards, locate a first card they are interested in, and then add or link to additional cards, that they know are in a general proximity of the first card, or share a related attribute. In this way the reader can quickly compose an itinerary of as many cards as they feel they want to accomplish that day.

FIG. 34 is an illustration of a booklet in accordance with an embodiment, showing how the ring fasteners can be separated to create two booklets (shown here side-by-side), including a primary booklet 240 and a secondary booklet 242. In those embodiments that use multiple rings or fasteners, then multiple books can be created.

FIG. 35 is an illustration of a booklet with removable cards in accordance with an embodiment, showing how the rings or fasteners can be connected to crate two sets of cards (a complete set, minus the day set) for easy reference to the day set during the day 244.

FIG. 36 is an illustration of a booklet with removable cards in accordance with an embodiment, showing how cards that were removed from the primary ring fastener and added to the secondary ring fastener can be carried separately 246. (The cards can subsequently be inserted back into the primary ring fastener to consolidate the booklet again).

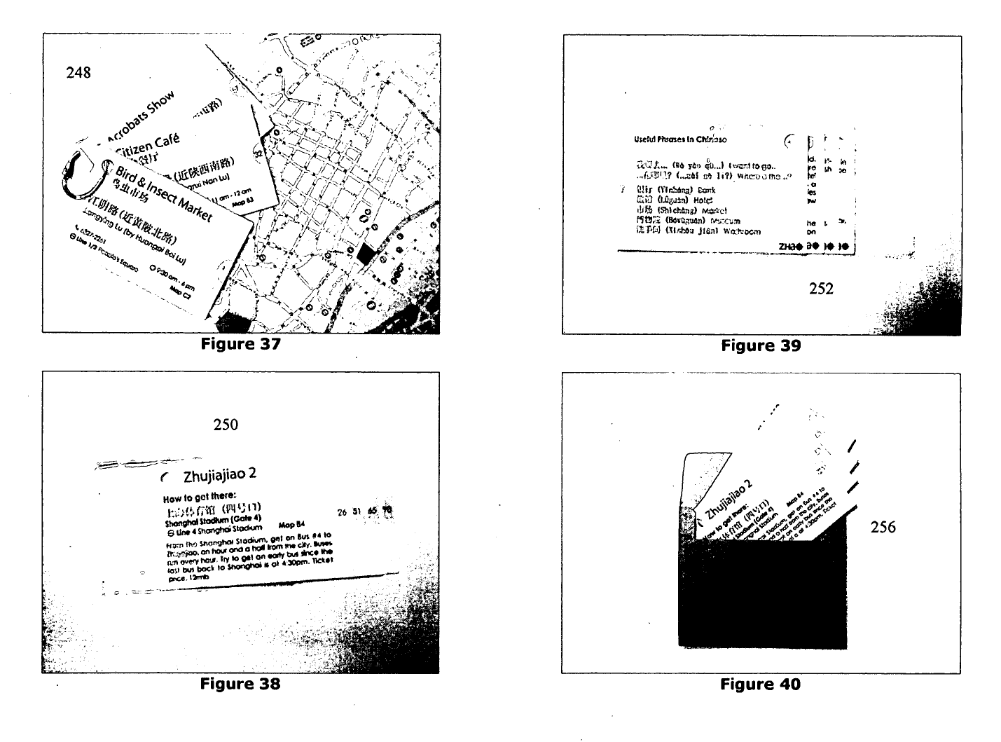

FIG. 37 is an illustration of a booklet 248 in accordance with an embodiment, showing how the secondary booklet can include a fold-out map.

FIG. 38 is an illustration of a booklet with removable cards in accordance with an embodiment, showing how cards can be packaged and/or carried in a pouch, holder, or wallet 250, instead of a secondary ring or fastener. The clear plastic wallet assists in showing, e.g. a taxicab driver or a local which of the cards and which entry the reader is interested in, without having to remove the card from the wallet.

FIG. 39 is another illustration of a booklet with removable cards in accordance with an embodiment, showing how cards can be packaged and/or carried in a pouch, holder, or wallet 252, instead of a secondary ring or fastener.

FIG. 40 is another illustration of a booklet with removable cards in accordance with an embodiment, showing how cards can be packaged and/or carried in a pouch, holder, or wallet 256, instead of a secondary ring or fastener.

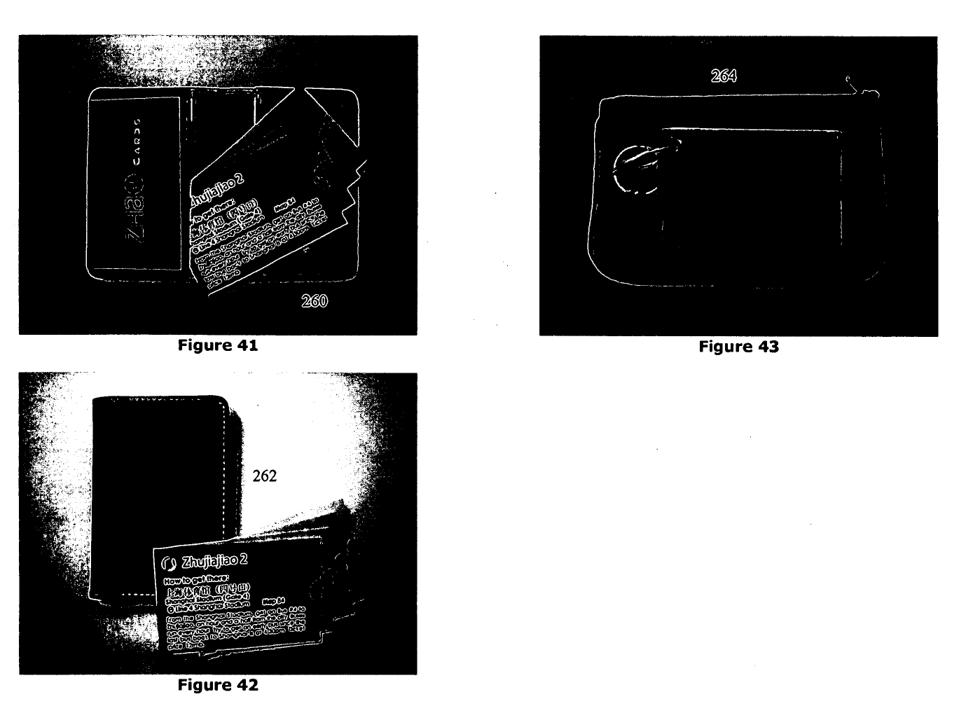

FIG. 41 is another illustration of a booklet with removable cards in accordance with an embodiment, showing how cards can be packaged and/or carried in a pouch, holder, or wallet 260, instead of a secondary ring or fastener.

FIG. 42 is another illustration of a booklet with removable cards in accordance with an embodiment, showing how cards can be packaged and/or carried in a pouch, holder, or wallet 262, instead of a secondary ring or fastener.

FIG. 43 is an illustration of a booklet with removable cards in accordance with an embodiment, showing how the entire booklet (or several booklets) can be packaged and/or carried in a pouch, holder, or wallet 264.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, while the various embodiments described above are described in the context of an English-to-Chinese language guide, it will be evident that the booklet and cards can be similarly developed or modified to suit any of the reader's own languages or reader's language of choice (for example, English, French, German), and the language of the destination country, region, or city (for example, Spanish, Japanese, Russian or another destination language), so that any number of different guides can be developed (for example, English-Spanish; or English-Russian). It will also be evident that cards can be developed to provide a plurality of different languages (for example, English-French-German on each card), and that the coloring, shading and symbol features can be changed to suit particular embodiments. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A booklet with removable cards as pages, comprising:
a first fastener, wallet, or carrying means, that can hold the plurality of cards to act as a booklet, and that can be opened by the reader so that a selection of one or more cards can be removed; and
a second fastener, wallet, or carrying means which can be used to carry the selection of one or more cards that are removed.

2. The booklet of claim 1 wherein at least one of the first fastener, wallet, or carrying means and the second fastener, wallet, or carrying means are ring fasteners.

3. The booklet of claim 1 wherein at least one of the first fastener, wallet, or carrying means and the second fastener, wallet, or carrying means is a wallet.

4. The booklet of claim 1 wherein the book is a map, catalogs, travel guides, schedule, or other printed information.

5. The booklet of claim 1 wherein each card has a unique number associated therewith within the guide book, and wherein the card includes suggestions for nearby attractions including the numbers of the cards associated with those attractions, and wherein a reader can select a first card, and use the suggestions to find one or more corresponding cards as desired to create an itinerary.

6. A guide book, comprising:
a plurality of information cards, wherein at least some of the information card provides information about a travel destination, language translation, cultural pointers, or other information;
a first fastener that can hold the plurality of information cards to form a book, and that can be opened by the reader so that one or more cards can be removed from the book; and
a second fastener or carrying means, onto which cards that are removed from the first fastener can be placed and carried separately as a second book, distinct from the book.

7. The guide book of claim 6 wherein the first fastener and the second fastener or carrying means are ring fasteners.

8. The guide book of claim 6 wherein the second fastener or carrying means is a wallet.

9. The guide book of claim 6 wherein the book is a map, catalogs, travel guides, schedule, or other printed information.

10. The guide book of claim 6 wherein each card has a unique number associated therewith within the guide book, and wherein the card includes suggestions for nearby attractions including the numbers of the cards associated with those attractions, and wherein a reader can select a first card, and use the suggestions to find one or more corresponding cards as desired to create an itinerary.

11. A guide book, comprising:
a plurality of information cards that provide information about a travel destination, language translation, cultural pointers, or other information, wherein each card has a hole punched therein to receive a ring fastener;
a first ring fastener that holds the plurality of information cards to form a main book, and that can be opened by the reader so that one or more of the cards can be removed from the main book; and
a second ring fastener, onto which cards that are removed from the first fastener can be placed and carried separately as a second book, distinct from the main book; and
wherein each card has a unique number associated therewith within the guide book, and wherein the card includes suggestions for nearby attractions including the numbers of the cards associated with those attractions, and wherein a reader can select a first card, and use the suggestions to find one or more corresponding cards as desired, and then add those cards to the second ring fastener to create an itinerary.
